(19) United States
(12) Patent Application Publication
(10) Pub. No.: US 2009/0033854 A1
(43) Pub. Date: Feb. 5, 2009

(54) Alignment film and liquid crystal panel using same and method for fabricating same

(75) Inventors: Hung-Ming Shen, Miao-Li (TW); Hung-Sheng Cho, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/221,577

(22) Filed: Aug. 4, 2008

(30) Foreign Application Priority Data
Aug. 3, 2007 (CN) 200710075533.6

(51) Int. Cl. G02F 1/1337; C09K 19/00; B05D 5/06

(52) U.S. Cl. 349/124; 252/299.4; 427/68

(57) ABSTRACT

An exemplary alignment film includes a plurality of orientation type molecules arranged homogeneously, and the orientation type molecules are arranged according to a direction of a field when the alignment film is formed. A liquid crystal panel using the alignment film and an exemplary method for fabricating the alignment film are also provided.

### FIELD OF THE INVENTION

The present invention relates to an alignment film having orientation type molecules arranged in an electric field or a magnetic field, a liquid crystal panel implementing the alignment film, and a method for fabricating the alignment film.

### BACKGROUND

A typical liquid crystal display (LCD) device has the advantages of portability, for example, low power consumption and low radiation, and has been widely used in various portable information products such as notebooks, personal digital assistants (PDAs), and video cameras. A liquid crystal panel is a major component of the LCD device, and generally includes two opposite substrates and a liquid crystal layer sandwiched between the two substrates. A pre-tilt angle of liquid crystal molecules of the liquid crystal layer is controlled by an alignment film disposed on an inner surface of the substrate, which impacts a display characteristic of the LCD device.

Referring to FIG. 11, a typical liquid crystal panel 100 includes two parallel substrates 110, a liquid crystal layer 120 sandwiched between the two substrates 110, and two alignment films 130. Each alignment film 130 is positioned on each substrate 110 adjacent to the liquid crystal layer 120. A plurality of parallel grooves 131 are formed on a surface of the alignment film 130 adjacent to the liquid crystal layer 120, and arranged homogeneously so that the liquid crystal molecules (not labeled) of the liquid crystal layer 120 are oriented uniformly along the grooves 131.

A typical method for fabricating the alignment film 130 includes: providing a substrate 110; coating a layer on the substrate 110 with an oriented material solution; fixing the substrate 110 to the layer in a drying device; pre-drying and baking to form an alignment film 130; rubbing the alignment film 130 with an orienting device to form a plurality of grooves 131.

Referring to FIG. 12, the orienting device (not labeled) includes a roller 10 and a stage 12. The stage 12 is used to support the substrate 110 and the alignment film 130, and move in a direction of the roller 10. A rubbing cloth 11 covers a surface of the roller 10. The roller 10 can rotate around its axis at a high speed. When the stage 12 and the substrate 110 move towards the roller 10, the rubbing cloth 11 contacts and rubs the alignment film 130 along the same direction, thereby forming grooves 131 on the surface of the alignment film 130 along the rubbing direction.

However, when the orienting device rubs the alignment film 130 at high speeds, the roller 10 is susceptible to vibration, resulting in irregular grooves 131. As a result, the liquid crystal molecules of the liquid crystal layer 120 adjacent to the alignment film 130 have an irregular arrangement and are liable to stack, which deteriorates the display characteristic of the liquid crystal panel 100.

Therefore, an improved alignment film is desired to overcome the above-described deficiencies.

### SUMMARY

An aspect of the invention relates to an alignment film including a plurality of orientation type molecules arranged homogeneously. The orientation type molecules are arranged according to a direction of a field when the alignment film is formed.

Other novel features and advantages will become more apparent from the following detailed description and when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a cross-sectional view of an embodiment of a liquid crystal panel, the liquid crystal panel including an alignment film, the alignment film including a plurality of orientation type molecules.

FIG. 2 is a schematic view of a structure of an orientation type molecule, the orientation type molecule including an arranged component, an oriented component, and a side chain component.

FIG. 3 is a view of a chemical construction of a polyimic acid group pertaining to the oriented component.

FIG. 4 is a view of a chemical construction of a polyimic group pertaining to the oriented component.

FIG. 5 is a view of a chemical construction of an electroconductive polymer group pertaining to the arranged component.

FIG. 6 is a view of a chemical construction of a neutral ion group pertaining to the arranged component.

FIG. 7 is a view of a chemical construction of a conjugate group pertaining to the arranged component.

FIG. 8 is a view of a chemical construction of a five-membered heterocyclic group of a heterocyclic group pertaining to the arranged component.

FIG. 9 is a flowchart illustrating a first embodiment of a method for fabricating the alignment film of FIG. 1.

FIG. 10 is a flowchart summarizing a second embodiment of a method for fabricating the alignment film of FIG. 1.

FIG. 11 is a cross-sectional view of a typical liquid crystal panel, the liquid crystal panel including an alignment film.

FIG. 12 is a schematic view of a typical orienting device for fabricating the alignment film of FIG. 11.

### DETAILED DESCRIPTION OF PREFERRED EMBODIMENTS

Reference will now be made to the drawings to describe embodiments in detail.

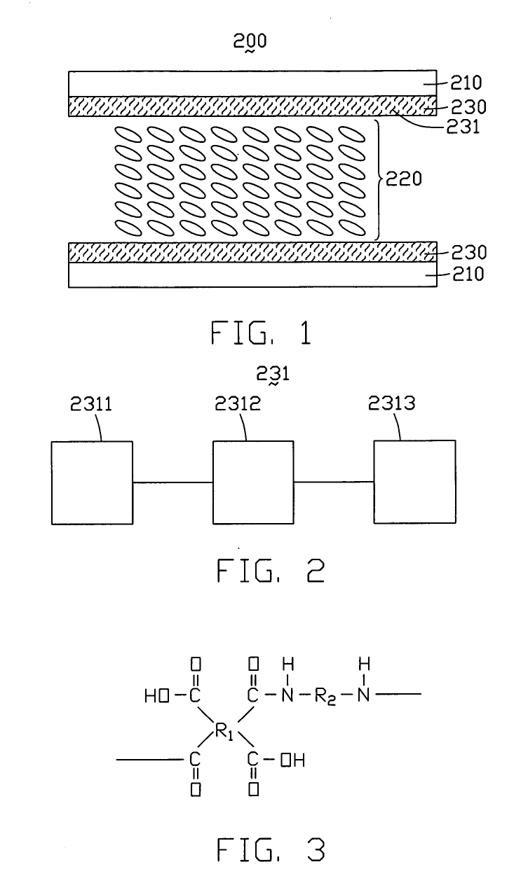

Referring to FIG. 1, an embodiment of a liquid crystal panel 200 includes two parallel substrates 210, a liquid crystal layer 220 sandwiched between the two substrates 210, and two alignment films 230. Each alignment film 230 is positioned on each substrate 210 adjacent to the liquid crystal layer 220. In other embodiments, the alignment film 230 is positioned on one of the two substrates 210, and a typical alignment film or no alignment film is positioned on the other substrate 210. The alignment film 230 includes a plurality of orientation type molecules 231 arranged homogeneously. An intermolecular interaction exists between the orientation type molecules 231 and liquid crystal molecules (not labeled) of the liquid crystal layer 220. Thus, the liquid crystal molecules are arranged homogeneously according to the orientation type molecules 231.

Referring to FIG. 2, a structure of one of the orientation type molecules 231 includes an arranged component 2311, an oriented component 2312, and a side chain component 2313 connected one by one. The arranged component 2311 is arranged according to a direction of an electric field or a magnetic field. The orientation type molecule 231 is arranged based on an arrangement of the arranged component 2311. The oriented component 2312 has a strong intermolecular interaction with the liquid crystal molecules, and affects orientation of the liquid crystal molecules. The side chain component 2313 controls a pre-tilt angle of the liquid crystal molecules.

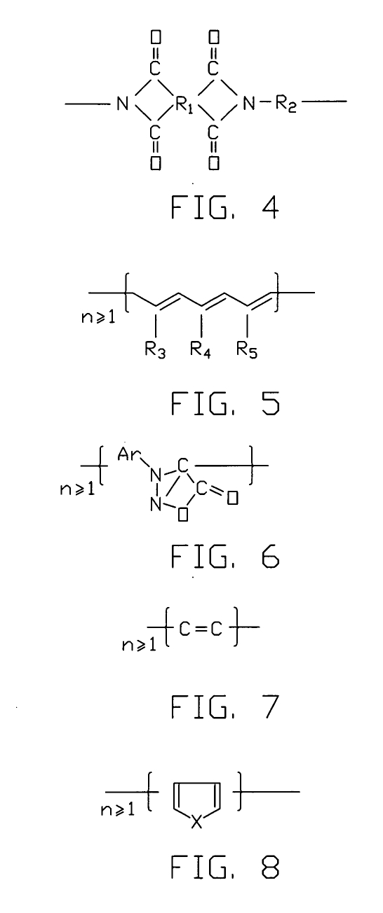

The oriented component 2312 may be a polyimic acid group or a polyimic group. A chemical construction of the polyimic acid group is shown in FIG. 3, and a chemical construction of the polyimic group is shown in FIG. 4. In one embodiment, the side chain component 2313 may be a long chain alkyl group, such as butyl (C₄H₉), or another alkyl group. The arranged component 2311 may be an electroconductive polymer group, a neutral ion group, a conjugate group, or a heterocyclic group. A chemical construction of the electroconductive polymer group is shown in FIG. 5, a chemical construction of the neutral ion group is shown in FIG. 6, and a chemical construction of the conjugate group is shown in FIG. 7.

The heterocyclic group may be a five-membered heterocyclic group, a six-membered heterocyclic group, or a fused heterocyclic group. A chemical construction of the five-membered heterocyclic group is shown in FIG. 8. The five-membered heterocyclic group may be a furan group, a furfural group, a thiophene group, a pyrrole group, a thiazole group, an imidazole group, or an oxazole group. The six-membered heterocyclic group may be a pyridine group, a pyrazine group, or a pyrimidine group. The fused heterocyclic group may be an indole group, a quinoline group, or a pteridine group.

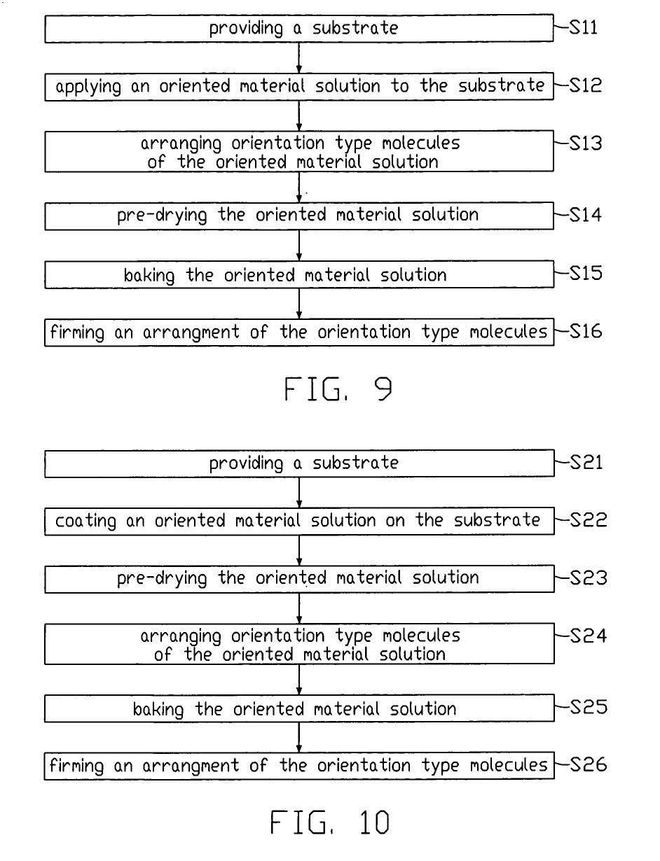

Referring to FIG. 9, a flow chart summarizing a first embodiment of a method for fabricating the alignment film 230 of the liquid crystal panel 200 is shown. Depending on the embodiment, certain of the blocks described below may be removed, others may be added, and the sequence of the blocks may be altered.

In a block S11, the substrate 210 is provided. The substrate 210 may be a thin film transistor substrate or a color filter substrate.

Continuing to a block S12, an oriented material solution is applied to the substrate 210. The oriented material solution is a mixture of an organic solvent and orientation type molecules 231, with a mass ratio of the organic solvent to the orientation type molecules 231 in a range of about 20:1 to about 1:1, preferably 8:1. The organic solvent includes at least one of N-methylpyrrolidone, γ-butryolactone, butyl cellosolve, dimethyl sulfoxide, acetone, chloroform, and ethanol. In another embodiment, the organic solvent can further include adding a cross linker to stabilize the arrangement of the orientation type molecules 231.

Moving to a block S13, the orientation type molecules 231 are arranged by placing the substrate 210 and the solution of oriented material in a stable electric or magnetic field. The arranged components 2311 are arranged homogeneously according to a direction of the electric field or the magnetic field. As a result, the orientation type molecules 231 are arranged homogeneously.

Continuing to a block S14, the substrate 210 and the solution of oriented material is placed in a drying device for pre-drying. In another embodiment, the substrate 210 may be placed in the electric or magnetic field to arrange the orientation type molecules 231 during the pre-drying process.

Moving to a block S15, the solution of oriented material on the substrate 210 is baked to form the alignment film 230. In another embodiment, the substrate 210 may be placed in the electric or magnetic field to arrange the orientation type molecules 231 during the baking process.

Continuing to a block S16, the arrangement of the orientation type molecules 231 is firmed by the addition of the cross linker, which strengthens the arrangement of the orientation type molecules 231. This block can be omitted if the cross linker is not added in the block S12.

In forming the alignment film 230 by the method described above, the orientation type molecules 231 are arranged homogeneously by the electric field or the magnetic field without a rubbing process, avoiding the stacking problem of liquid crystal molecules in the liquid crystal layer 220. In addition, the addition of a cross linker fortifies the arrangement of the orientation type molecules 231 and further prevents the arrangement of the orientation type molecules 231 from being affected by an electric field generated when the liquid crystal panel 200 is in operation.

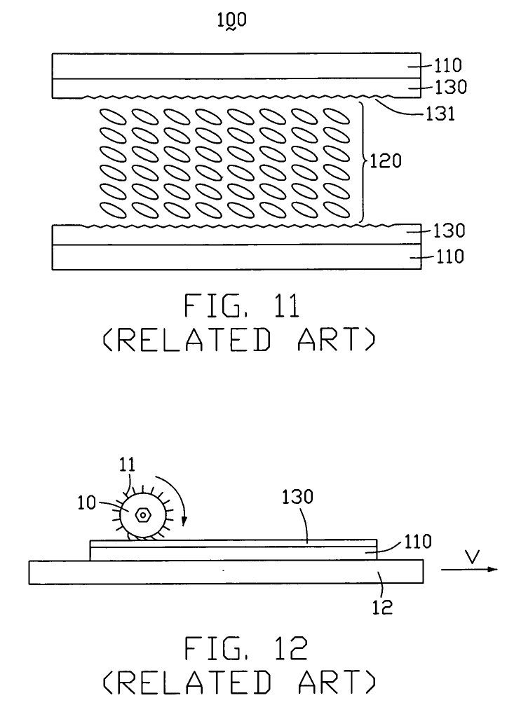

Referring to FIG. 10, a flow chart illustrating a second embodiment of a method for fabricating the alignment film 230 is shown. The second method is similar to the method of FIG. 9, except that the oriented material solution is pre-dried prior to arranging the orientation type molecules 231. Depending on the embodiment, certain of the blocks described below may be removed, others may be added, and the sequence of the blocks may be altered. In a block S21, a substrate 210 is provided. Moving to a block S22, an oriented material solution is coated on the substrate 210. Continuing to a block S23, the oriented material solution is pre-dried. Moving to a block S24, the orientation type molecules of the oriented material solution are arranged. Continuing to a block S25, the solution of oriented material on the substrate 210 is baked to form the alignment film 230. Moving to a block S26, the arrangement of the orientation type molecules 231 is firmed.

It is to be understood that even though numerous characteristics and advantages of the present embodiments have been set forth in the foregoing description with details of the structures and functions of the embodiments, the disclosure is illustrative only, and changes made in detail, especially in matters of shape, size, and arrangement of parts, within the principles of the embodiments, to the full extent indicated by the broad general meaning of the terms in which appended claims are expressed.

What is claimed is:

1. An alignment film, comprising a plurality of orientation type molecules arranged homogeneously, the orientation type molecules are arranged according to a direction of a field when the alignment film is formed.

2. The alignment film of claim 1, wherein each orientation type molecule comprises an arranged component, an oriented component connected to the arranged component, and a side chain component connected to the oriented component; the field is selected from a group consisting of an electric field and a magnetic field.

3. The alignment film of claim 2, wherein the arranged component is selected from an electroconductive polymer group consisting of a neutral ion group, a conjugate group, and a heterocyclic group.

4. The alignment film of claim 3, wherein the heterocyclic group is selected from a group consisting of a five-membered heterocyclic group, a six-membered heterocyclic group, and a fused heterocyclic group.

5. The alignment film of claim 4, wherein the five-membered heterocyclic group is selected from a group consisting of a furan group, a furfural group, a thiophene group, a pyrrole group, a thiazole group, an imidazole group, and an oxazole group.

6. The alignment film of claim 4, wherein the six-membered heterocyclic group is selected from a group consisting of a pyridine group, a pyrazine group, and a pyrimidine group.

7. The alignment film of claim 4, wherein the fused heterocyclic group is selected from a group consisting of an indole group, a quinoline group, and a pteridine group.

8. The alignment film of claim 2, wherein the oriented component is selected from a group consisting of a polyimic acid group and a polyimic group.

9. The alignment film of claim 2, wherein the side chain component is a long chain alkyl group.

10. A liquid crystal panel, comprising:
two parallel substrates;
a liquid crystal layer sandwiched between the two substrates; and
at least one alignment film adjacent to the liquid crystal layer;
wherein the at least one alignment film comprises a plurality of orientation type molecules arranged homogeneously according to a direction of a field.

11. The liquid crystal panel of claim 10, wherein each the orientation type molecule comprises an arranged component, an oriented component connected to the arranged component, and a side chain component connected to the oriented component; the arranged component is positioned adjacent to the substrate; the field is selected from a group consisting of an electric field and a magnetic field.

12. The liquid crystal panel of claim 11, wherein the arranged component arranges the orientation type molecule.

13. The liquid crystal panel of claim 12, wherein the oriented component has an intermolecular interaction with the liquid crystal molecules.

14. The liquid crystal panel of claim 13, wherein the side chain component controls a pre-tilt angle of the liquid crystal molecules.

15. A method for fabricating an alignment film, comprising:
providing an oriented material solution, the oriented material solution comprising a plurality of orientation type molecules;
coating the oriented material solution on a substrate;
arranging the orientation type molecules in a field.

16. The method of claim 15, further comprising:
pre-drying the oriented material solution;
baking the oriented material solution.

17. The method of claim 16, wherein pre-drying the oriented material solution is performed before arranging the orientation type molecules; baking the oriented material solution is performed after arranging the orientation type molecules.

18. The method of claim 15, wherein the oriented material solution further comprises an organic solvent; a mass ratio of the organic solvent to the orientation type molecules is in a range of about 20:1 to about 1:1.

19. The method of claim 18, wherein the organic solvent comprises at least one of N-methylpyrrolidone, γ-butryolactone, butyl cellosolve, dimethyl sulfoxide, acetone, chloroform, and ethanol.

20. The method of claim 19, wherein the organic solvent further comprises a cross linker, the cross linker is used to strengthen the arrangement of the orientation type molecules.
